(19) United States
(12) Patent Application Publication
(10) Pub. No.: US 2013/0068922 A1
(43) Pub. Date: Mar. 21, 2013

(54) MOUNTING DEVICE FOR FAN

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/241,279

(22) Filed: Sep. 23, 2011

(30) Foreign Application Priority Data
Sep. 16, 2011 (CN) 201110275061.5

(51) Int. Cl. F16M 13/00

(52) U.S. Cl. 248/674

(57) ABSTRACT

A mounting device for fixing a fan includes a board, and a frame mounted to an end of the fan. The board defines a vent. Two L-shaped blocking pieces are formed on the board at opposite sides of the vent. The frame is sandwiched between the blocking pieces and the board.

### BACKGROUND

1. Technical Field

The present disclosure relates to a device for fixing a fan.

2. Description of Related Art

Many electronic devices use fans to cool electronic components. A fan may be mounted in an electronic device with screws, which is difficult and time-consuming when installing or removing the fan.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device together with a fan; wherein the mounting device includes a frame.

FIG. 2 is an isometric view of the frame and the fan of FIG. 1.

FIG. 3 is an isometric view of the fan and mounting device of FIG. 1 in an assembled state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

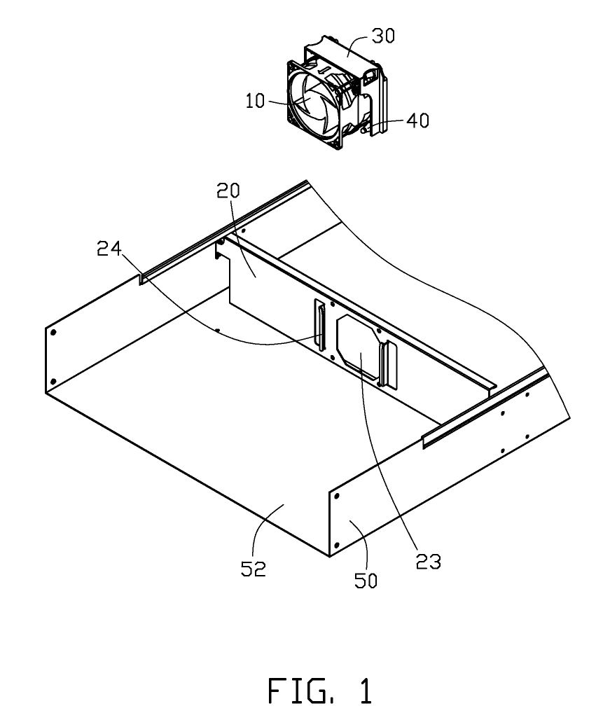

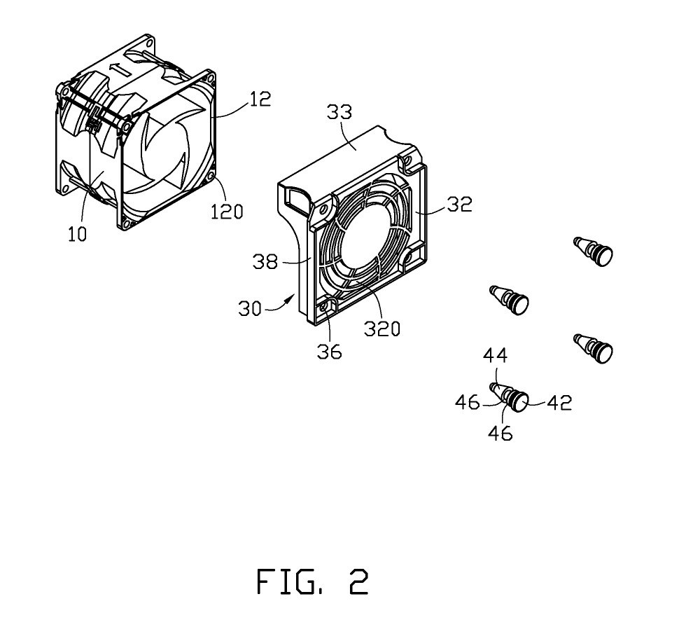

Referring to FIGS. 1 and 2, an exemplary embodiment of a mounting device for fixing a fan 10 includes a board 20, a frame 30 and four fasteners 40.

The fan 10 includes an end board 12 defining four corner holes 120.

The board 20 can be installed in an electronic device so that airflow from the fan 10 is directed as desired. In this embodiment, the board 20 is installed to a bottom wall 52 of a chassis 50 of an electronic device. The board 20 defines a vent 23. Two substantially L-shaped blocking pieces 24 are symmetrically disposed at opposite sides of the vent 23 with short legs of the blocking pieces 24 extending toward each other.

The frame 30 includes a rectangular plate 32 defining a vent 320 and a surrounding wall 33 perpendicularly extending from sides of the plate 32. The plate 32 defines four corner holes 36. Two inserting pieces 38 extend from two opposite sides of the plate 32 and are perpendicular to the surrounding wall 33.

The fasteners 40 are made of elastic material for absorbing vibration. Each fastener 40 includes a head 42 and a tapered extension potion 44 extending from the head 42. Two parallel annular slots 46 are defined in the circumference of the extension portion 44.

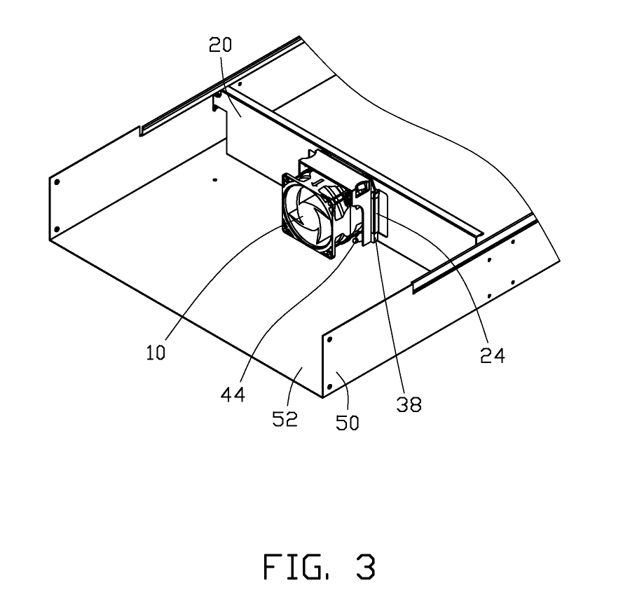

Referring to FIG. 3, to install the fan 10 in the frame 30, the fan 10 is placed within the surrounding wall 33. The fan 10 is aligned with the vent 320. The corner holes 36 are aligned with the corresponding corner holes 120. The extension portions 44 are extended through the corresponding corner holes 36 and 120, until the plate 32 and the end board 12 are engaged in the corresponding slots 46.

The inserting pieces 38 are inserted into the space (not labeled) between the blocking pieces 24 and the board 20, and the bottom ends of the inserting pieces 38 contact the bottom wall 52, thereby fixing the frame 30 to the board 20. The vent 23 is aligned with the vent 320.

In uninstalling the fan 10, the frame 30 is moved up to disengage the inserting pieces 38 from the blocking pieces 24, releasing the fasteners 40.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for fixing a fan, comprising:
a board defining a first vent, wherein two L-shaped blocking pieces facing each other extend from the board at opposite sides of the first vent; and
a frame to be mounted to an end of the fan, and sandwiched between the blocking pieces and the board.

2. The mounting device of claim 1, wherein the frame comprises a plate defining a second vent aligning with the first vent, and a surrounding wall extending from sides of the plate to receive the fan; two inserting pieces extend from opposite sides of the plate to be inserted between the blocking pieces and the board.

3. The mounting device of claim 2, further comprising a plurality of fasteners extending through the plate to be engaged in the fan.

4. The mounting device of claim 3, wherein the fasteners are made of an elastic material.

5. The mounting device of claim 4, wherein each fastener comprises a head and an extension portion extending from the head, two parallel slots are defined in the extension portion to be respectively engaged with the plate and the fan.
